(19) United States
(12) Patent Application Publication
(10) Pub. No.: US 2024/0261961 A1
(43) Pub. Date: Aug. 8, 2024

(54) METHOD FOR ROBOT JOGGING THROUGH A GRAPHICAL USER INTERFACE

(71) Applicant: MÉCADÉMIC INC., Montreal (CA)

(72) Inventors: Alain BRASSARD, Montreal (CA); Jasmin LETENDRE, Montreal (CA); Louis-Xavier FALARDEAU, Montreal (CA); Christian BILODEAU, Montreal (CA); Ilian BONEV, Montreal (CA)

(73) Assignee: MÉCADÉMIC INC., Montreal (CA)

(21) Appl. No.: 18/432,714

(22) Filed: Feb. 5, 2024

Related U.S. Application Data
(60) Provisional application No. 63/443,621, filed on Feb. 6, 2023.

(51) Int. Cl. B25J 9/16; B25J 13/08

(52) U.S. Cl. CPC B25J 9/161; B25J 13/088

(57) ABSTRACT

System and methods for jogging a robot end-effector in constant awareness. On a graphical user interface is displayed, dynamically in real-time while the robot is moving, a current position and a relative indicator for the current position for each of a plurality of joints of the robot. A position of the relative indicator for each of the plurality of joints is proportional to an actual position of a corresponding joint with respect to physical limits thereof. Is also displayed three or more input elements, each having clickable buttons at extremities thereof and a thumb marker movable along at least one of a curvilinear track and across an area. Each of the three or more input elements is associated with at least one of: one or two of the plurality of joints of the robot and one or two degrees of freedom of the robot end-effector.

### CROSS-REFERENCE TO RELATED APPLICATION

This non-provisional patent application claims priority based upon the prior U.S. provisional patent application entitled “Method for robot jogging through a graphical user interface”, application number 63/443,621, filed Feb. 6, 2023, in the name of Mecademic Inc., which is hereby incorporated by reference in its entirety.

### TECHNICAL FIELD

The invention relates generally to robotics and more specifically to a graphical user interface for jogging of robot arms.

### BACKGROUND

Industrial robot arms, especially those with six joints, also known as six-axis robot arms, are particularly difficult to maneuver, i.e., jog, in desired directions, while trying to achieve robot positions that are to be saved as part of a programmed robot motion (a process known as teaching).

The present disclosure proposes a solution that at least partially addresses this difficulty.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method for directly displacing an end-effector or joint of a robot is provided. The method comprises providing the end-effector or joint on a robot arm of the robot in at least one of a virtual world and the real world. The method also includes displaying, dynamically in real-time while the robot is moving, a current position and a relative indicator for the current position for each of a plurality of joints of the robot on a graphical user interface. A position of the relative indicator for each of the plurality of joints is proportional to an actual position of a corresponding joint with respect to physical limits thereof. The method also includes displaying three or more input elements on the graphical user interface, each of the three or more input elements having clickable buttons at extremities thereof and a thumb marker movable along at least one of a curvilinear track and across an area. Each of the three or more input elements is associated with at least one of: one or two joints of the plurality of joints of the robot; and one or two degrees of freedom of the robot end-effector. The method also includes, upon receiving a click event over the clickable buttons, causing the robot to jog at at least one of a maximum speed and an increment in a corresponding direction. The method also includes, upon receiving a click dragging motion from a mouse or a tactile input over one of the thumb markers, determining characteristics of the click dragging motion of the dragged thumb marker and controlling movement speed of the end-effector or joint from the characteristics of the click dragging motion. The characteristics comprise at least one of relative position of the thumb marker from a neutral point and a speed of movement of the mouse or tactile input pointer. The method also includes releasing the click dragging motion causing the thumb marker to return to its neutral point. Other embodiments of this aspect include corresponding computer systems, apparatus, and computer programs recorded on one or more computer storage devices, each configured to perform the actions of the methods.

Optionally, one or both of the maximum speed and increment may be configurable. Displaying the current position for each of the joints of the robot may optionally be performed in a text field. The position of the relative indicator for each of the joints may optionally be displayed with respect to a left limit and a right limit of a corresponding text field. Implementations of the described techniques may include hardware, a method or process, or a computer tangible medium.

In one general aspect, a method for directly displacing an end-effector or joint of a robot is provided. The method comprises providing the end-effector or joint on a robot arm of the robot in at least one of a virtual world and the real world. The method also includes displaying, dynamically in real-time while the robot is moving, a current position and a relative indicator for the current position for each of a plurality of joints of the robot on a graphical user interface. At least one of a background and style of a text displaying the current position for each of the robot joints changes when the corresponding joint approaches a limit or a singular configuration. The method also includes displaying three or more input elements on the graphical user interface, each of the three or more input elements having clickable buttons at extremities thereof and a thumb marker movable along at least one of a curvilinear track and across an area. Each of the three or more input elements is associated with at least one of: one or two joints of the plurality of joints of the robot; and one or two degrees of freedom of the robot end-effector. The method also includes, upon receiving a click event over the clickable buttons, causing the robot to jog at at least one of a maximum speed and an increment in a corresponding direction. The method also includes, upon receiving a click dragging motion from a mouse or a tactile input over one of the thumb markers, determining characteristics of the click dragging motion of the dragged thumb marker and controlling movement speed of the end-effector or joint from the characteristics of the click dragging motion. The characteristics comprise at least one of relative position of the thumb marker from a neutral point and a speed of movement of the mouse or tactile input pointer. The method also includes releasing the click dragging motion causing the thumb marker to return to its neutral point. Other embodiments of this aspect include corresponding computer systems, apparatus, and computer programs recorded on one or more computer storage devices, each configured to perform the actions of the methods.

Implementations may include one or more of the following features. Method where one or both of the maximum speed and increment are configurable. Method where the position of the relative indicator for each of the joints is displayed with respect to a left limit and a right limit of a corresponding text field. Implementations of the described techniques may include hardware, a method or process, or a computer tangible medium.

In one general aspect, a system is provided comprising a robot arm of the robot in at least one of a virtual world and the real world, a graphical user interface and one or more processors. The one or more processors are configured to display, dynamically in real-time while the robot is moving, a current position and a relative indicator for the current position for each of a plurality of joints of the robot on the graphical user interface. A position of the relative indicator for each of the plurality of joints is proportional to an actual position of a corresponding joint with respect to physical limits thereof. The one or more processors are also configured to display three or more input elements on the graphical user interface, each of the three or more input elements having clickable buttons at extremities thereof and a thumb marker movable along at least one of a curvilinear track and across an area. Each of the three or more input elements is associated with at least one of: one or two of the plurality of joints of the robot and one or two degrees of freedom of the robot end-effector. The one or more processors are also configured to, upon receipt of a click event over the clickable buttons, cause the robot to jog at at least one of a maximum speed and an increment in a corresponding direction. The one or more processors are also configured to, upon receipt of a click dragging motion from a mouse or a tactile input over one of the thumb markers, determine characteristics of the click dragging motion of the dragged thumb marker. The one or more processors are also configured to control movement speed of the end-effector or joint of the robot from the characteristics of the click dragging motion, the characteristics having at least one of relative position of the thumb marker from a neutral point and a speed of movement of the mouse or tactile input pointer. The one or more processors are also configured to release the click dragging motion causing the thumb marker to return to its neutral point. Other embodiments of this aspect include corresponding computer systems, apparatus, and computer programs recorded on one or more computer storage devices, each configured to perform the actions of the methods.

Implementations may include one or more of the following features. One or both of the maximum speed and the increment may optionally be configurable. The one or more processors may optionally be further configured to display the current position for each of the joints of the robot in a text field. The position of the relative indicator for each of the joints may optionally be displayed with respect to a left limit and a right limit of a corresponding text field. A background and style of a text displaying the current position of each of the robot joints may optionally change when a corresponding joint approaches a limit or a singular configuration. Implementations of the described techniques may include hardware, a method or process, or a computer tangible medium.

### BRIEF DESCRIPTION OF THE DRAWINGS

Further features and exemplary advantages of the present invention will become apparent from the following detailed description, taken in conjunction with the appended drawings, in which:

FIGS. 1 and 2 depict graphical user interfaces for jogging multi-axis robot manipulators in joint mode and Cartesian mode, respectively.

FIG. 3 illustrates an example of a graphical user interface for jogging of multi-axis robot manipulators in joint mode.

FIG. 4 illustrates an example of a graphical user interface for jogging of multi-axis robot manipulators in Cartesian mode.

FIG. 5 illustrates an example of a graphical user interface with a jogging pad for jogging of multi-axis robot manipulators.

FIG. 6 illustrates an example of a graphical user interface displaying a robot Cartesian and joint data together with configuration parameters.

### DETAILED DESCRIPTION

Jogging a robot's end-effector is often a frustrating task because of joint limits and singularities, which are difficult to anticipate, as well as other motion inhibitors such as link interferences and limited link lengths, which are easier to foresee while observing the moving robot. An operator of the robot would jog the end-effector in one direction (e.g., along a line) and then the robot would suddenly stop, often displaying some generic motion error.

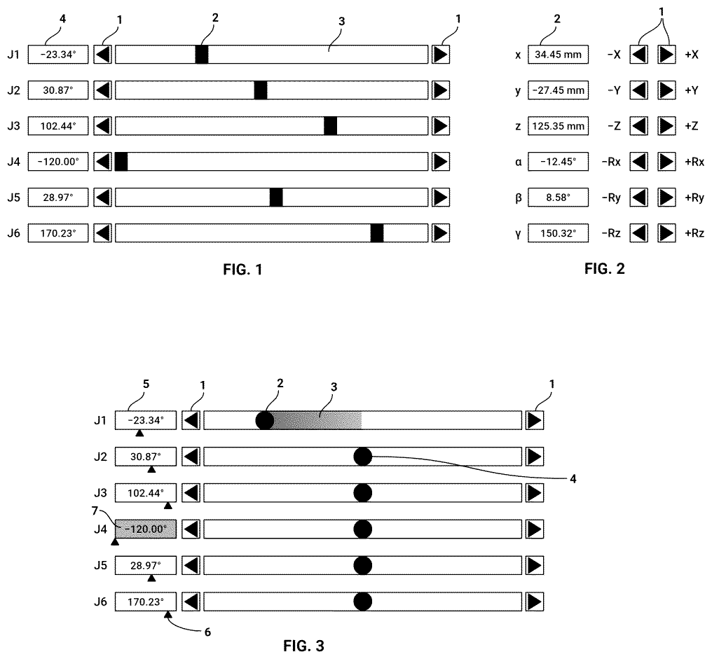

Indeed, robot manufacturers may provide two exclusive ways of jogging a robot: joint mode and Cartesian mode. In joint mode, the operator moves each joint individually using a physical three-axis or six-axis joystick, six traditional sliders on a graphical user interface (GUI), or simply twelve buttons (e.g., +J1, −J1, +J2, −J2, +J3, −J3, +J4, −J4, +J5, −J5, +J6, −J6). As shown in FIG. 1, each slider is composed of two actionable (clickable) arrow buttons 1, and a non-actionable (non-clickable) thumb 2 moving along a jogging bar or track 3 and indicating the current position of the joint with respect to corresponding joint limits. In addition, the joint position is often displayed in a text field 4 either on one side of each slider 3, as in FIG. 1, or directly on or above the moving thumb.

In Cartesian mode, the operator controls the linear motion of the robot end-effector along each of the three axes of some Cartesian coordinate system centered at some user-defined point in the end-effector (called the tool center point or TCP), and the rotational motion of the end-effector about the same three axes. Means for controlling these six degrees of freedom vary between the use of a three-axis or a six-axis joystick, or simply, as in FIG. 2, twelve buttons 1, named +X, −X, +Y, −Y, +Z, −Z, +Rx, −Rx, +Ry, −Ry, +Rz, and −Rz. While jogging in Cartesian mode using the interface as depicted FIG. 2., the operator is not shown the position of the robot joints with respect to corresponding joint limits, let alone the proximity to so-called singularities, where the robot's end-effector loses one or more degrees of freedom. Since the workspace of a robot is an extremely intricate six-dimensional entity, the limits in terms of Cartesian position coordinates (x, y, z) are not shown as Cartesian position coordinates (x, y, z) are difficult to calculate in real time. However, as in FIG. 2, the current position (x, y and z) and orientation (three Euler angles) of the end-effector are shown in text fields 2.

In both jogging modes, when using a physical joystick, the farther the joystick is pushed, the faster the robot joint or robot end-effector is moving. However, when jogging without a physical joystick, continuously pressing said buttons (+J1, −J1, +X, −X, etc.) makes the robot joint or robot end-effector move with constant speed. The operator must therefore frequently decrease or increase the jogging speed, through separate buttons or other GUI elements, rendering the jogging process tedious and prone to robot collisions.

A multi-functional GUI element with intuitive visual cues to facilitate the jogging of robot arms is described hereinbelow. As skilled persons will recognize, the intuitive visual cues are technical elements that are provided to the robot operator. The technical elements are required to ensure that movements of the robot are not impeded by lack of awareness on the part of the robot operator of a continuously evolving robot configuration. In the context of the present disclosure, a robot configuration may be defined as a dataset comprising a current position of each of the joints of the robot (e.g., angular value, 3D spatial coordinates, etc.) as well as a current position of the end effector (e.g., 3D spatial coordinates, angular position of the end-effector, etc.). The dataset may further comprise one or more status indicators for the joints and/or the end-effector (e.g., relative value of the remaining joint range, Boolean status of a joint configuration, etc.).

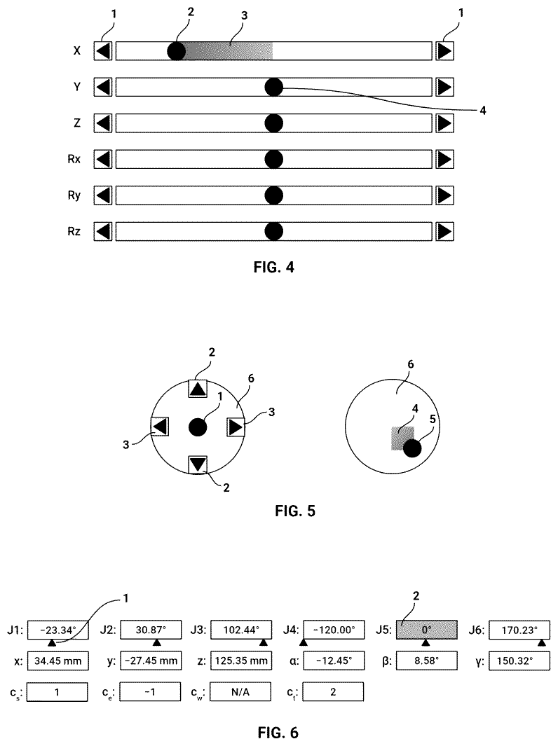

GUI input elements for both Cartesian mode and joint jogging mode comprise a slider, also referred to as a jogging bar, similar to a single-axis virtual joystick. As shown in FIG. 3 and FIG. 4, the GUI input elements also comprise a left clickable button 1 and a right clickable button 1 at extremities of a horizontal linear track and of a clickable (or actionable) thumb marker 2 that can be directly displaced (e.g., dragged) along the horizontal linear track. To jog the robot end-effector along a given degree of freedom or to jog a robot joint, the robot operator “grabs” the thumb marker 2 and drags the thumb marker 2 left or right (e.g., using the primary mouse button or by touching a screen on which the GUI elements are displayed). The farther the thumb marker 2 is displaced from a central position 4, the faster the robot end-effector or joint moves, as could be expected from operation of a single-axis joystick. The relationship between the relative displacement of the thumb marker 2 and the jogging speed may be set in various manners such as a proportional relation or more complex relation (e.g., quadratic). Space between the thumb marker 2 and a central or neutral position thereof may be gradient colored, 3, which may further increase visual feedback, thereby improving awareness of the operator. Once the thumb marker 2 is released, the robot stops moving, and said thumb marker 2 automatically “springs” back (e.g., moves fast or instantly) to the central position, 4. Pressing with the primary mouse button or touching the left or right clickable buttons 1 brings the thumb marker 2 to an extreme left position or an extreme right position.

The present disclosure supports combining two jogging bars into a single two-axis virtual joystick, also referred to herein as a jogging pad, that has the same characteristics as said jogging bars 3 but allows the possibility to move in two directions at the same time. As shown in FIG. 5, said jogging pad consists of a single thumb 1 that can be dragged within a circular, or other, area 6. In said area 6, left and right arrow buttons 3 are provided for maximum-speed jogging in one of the two directions, and up and down buttons 2 are provided for maximum-speed jogging in the other direction. A label such as +J1, −J1, +X, −X, etc. may also be shown next to each of the four buttons (not represented in FIG. 5). Once the thumb 1 is clicked, said four arrow buttons (and their labels) may disappear, as exemplified in FIG. 5 on the right. Similar to said jogging bar, a gradient-colored rectangle 4 could be drawn between the center of the area and the center of the moved thumb 5.

When using a mouse to interact with said virtual joysticks, using the secondary mouse button could provide a different functionality. When the operator clicks and holds the secondary mouse button on the thumb 1 of said jogging bar or pad, dragging the mouse along the screen could directly map the mouse speed (rather than the mouse relative position) to the speed of the robot along the selected end-effector degree(s) of freedom or joint(s). The operator is then free to observe the robot instead of the interface, thereby improving the operator awareness. Again, the relationship between the mouse speed and robot jogging speed could be linear or a more complex one.

In addition, clicking the arrows 2, 3 of said virtual joysticks with the secondary mouse button commands a single incremental movement (also known as inching), the magnitude of said incremental motion may further be configurable in a separate GUI element (not shown).

Finally, the joint positions may be displayed in text boxes on the GUI, which could be editable, as in FIG. 2, or not, as in FIG. 4. To warn the operator when the robot is close to a joint limit or a singularity, said virtual joysticks could be enhanced with one or more visual cues. In some embodiments, each of the joint positions are displayed in the text boxes at all times, thereby allowing constant awareness of the robot configuration in real-time during all movements.

An example of a visual cue is a pointer (element 6 depicted in FIG. 3 and element 1 10 depicted in FIG. 6), directly beneath each text boxes showing joint data. The horizontal location of said pointer 1, 6 with respect to the end-points of the text field is directly proportional to the position of the joint with respect to the joint limits.

Another example of a visual cue is the changing background (element 7 in FIG. 3 and element 2 in FIG. 6) of the joint data text boxes. Depending on the distance of a joint position to a limit or when the joint position is at the limit, the background of the corresponding box field may be changed to a “warning” color (e.g., yellow or orange) and to an “error” color (e.g., red), respectively.

A singularity can be defined as a special geometric condition on the axes of the revolute joints of a robot arm resulting in the loss of an end-effector degree of freedom. In most six-axis robot arms, there exist three such conditions, i.e., three types of singularities: a wrist singularity, an elbow singularity, and a shoulder singularity. When the position of joint #5 is close to or at what is known as a wrist singularity or the position of joint #3 is close to or at what is known as elbow singularity, the corresponding text field background may be changed to “warning” color, or “error” color, respectively. Similarly, when the robot configuration is close to or at what is known as shoulder singularity, the text field backgrounds of joints #2 and #3 (in the case of most six-axis robot arms), and possibly #4 and #5 (in the case of other robot architectures) are changed to “warning” color, or “error” color, respectively. Instead of changing the background of the joint data text fields, the style of the text itself can be changed (for example, the color of the text could change or the text could begin to blink).

The present invention is not affected by the way different modules exchange information between them. For instance, a memory module and a processor module could be connected by a parallel bus, but could also be connected by a serial connection or involve an intermediate module without affecting the teachings of the present invention.

A method is generally conceived to be a self-consistent sequence of steps leading to a desired result. These steps require physical manipulations of physical quantities. Usually, though not necessarily, these quantities take the form of electrical or optical signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for directly displacing an end-effector or joint of a robot comprising:
providing the end-effector or joint on a robot arm of the robot in at least one of a virtual world and the real world;
displaying, dynamically in real-time while the robot is moving, a current position and a relative indicator for the current position for each of a plurality of joints of the robot on a graphical user interface, a position of the relative indicator for each of the plurality of joints being proportional to an actual position of a corresponding joint with respect to physical limits thereof;
displaying three or more input elements on the graphical user interface, each of the three or more input elements comprising clickable buttons at extremities thereof and a thumb marker movable along at least one of a curvilinear track and across an area, each of the three or more input elements being associated with at least one of:
one or two joints of the plurality of joints of the robot; and
one or two degrees of freedom of the robot end-effector;
upon receiving a click event over the clickable buttons, causing the robot to jog at at least one of a maximum speed and an increment in a corresponding direction;
upon receiving a click dragging motion from a mouse or a tactile input over one of the thumb markers, determining characteristics of the click dragging motion of the dragged thumb marker;
controlling movement speed of the end-effector or joint from the characteristics of the click dragging motion, the characteristics comprising at least one of relative position of the thumb marker from a neutral point and a speed of movement of the mouse or tactile input pointer; and
releasing the click dragging motion causing the thumb marker to return to its neutral point.

2. The method of claim 1, wherein one or both of the maximum speed and increment are configurable.

3. The method of claim 1, further comprising displaying the current position for each of the joints of the robot in a text field.

4. The method of claim 1, wherein the position of the relative indicator for each of the joints is displayed with respect to a left limit and a right limits of a corresponding text field.

5. A method for directly displacing an end-effector or joint of a robot comprising:
providing the end-effector or joint on a robot arm of the robot in at least one of a virtual world and the real world;
displaying, dynamically in real-time while the robot is moving, a current position and a relative indicator for the current position for each of a plurality of joints of the robot on a graphical user interface, wherein at least one of a background and style of a text displaying the current position for each of the robot joints changes when the corresponding joint approaches a limit or a singular configuration;
displaying three or more input elements on the graphical user interface, each of the three or more input elements comprising clickable buttons at extremities thereof and a thumb marker movable along at least one of a curvilinear track and across an area, each of the three or more input elements being associated with at least one of:
one or two joints of the plurality of joints of the robot; and
one or two degrees of freedom of the robot end-effector;
upon receiving a click event over the clickable buttons, causing the robot to jog at at least one of a maximum speed and a increment in a corresponding direction;
upon receiving a click dragging motion from a mouse or a tactile input over one of the thumb markers, determining characteristics of the click dragging motion of the dragged thumb marker;
controlling movement speed of the end-effector or joint from the characteristics of the click dragging motion, the characteristics comprising at least one of relative position of the thumb marker from a neutral point and a speed of movement of the mouse or tactile input pointer; and
releasing the click dragging motion causing the thumb marker to return to its neutral point.

6. The method of claim 5, wherein one or both of the maximum speed and increment are configurable.

7. The method of claim 5, wherein the position of the relative indicator for each of the joints is displayed with respect to a left limit and a right limit of a corresponding text field.

8. A system for directly displacing an end-effector or joint of a robot comprising:
a robot arm of the robot in at least one of a virtual world and the real world;
a graphical user interface;
one or more processors configured to:
display, dynamically in real-time while the robot is moving, a current position and a relative indicator for the current position for each of a plurality of joints of the robot on the graphical user interface, a position of the relative indicator for each of the plurality of joints being proportional to an actual position of a corresponding joint with respect to physical limits thereof;
display three or more input elements on the graphical user interface, each of the three or more input elements comprising clickable buttons at extremities thereof and a thumb marker movable along at least one of a curvilinear track and across an area, and, each of the three or more input elements being associated with at least one of:
one or two of the plurality of joints of the robot and
one or two degrees of freedom of the robot end-effector;
upon receipt of a click event over the clickable buttons, cause the robot to jog at at least one of a maximum speed and an increment in a corresponding direction;
upon receipt of a click dragging motion from a mouse or a tactile input over one of the thumb markers, determine characteristics of the click dragging motion of the dragged thumb marker;
control movement speed of the end-effector or joint of the robot from the characteristics of the click dragging motion, the characteristics comprising at least one of relative position of the thumb marker from a neutral point and a speed of movement of the mouse or tactile input pointer; and
release the click dragging motion causing the thumb marker to return to its neutral point.

9. The system of claim 8, wherein one or both of the maximum speed and the increment are configurable.

10. The system of claim 8, wherein the one or more processors are further configured to display the current position for each of the joints of the robot in a text field.

11. The system of claim 8, wherein the position of the relative indicator for each of the joints is displayed with respect to a left limit and a right limit of a corresponding text field.

12. The system of claim 8, wherein at least one of a background and style of a text displaying the current position of each of the robot joints changes when a corresponding joint approaches a limit or a singular configuration.
